(19) United States
(12) Patent Application Publication
(10) Pub. No.: US 2004/0256428 A1
(43) Pub. Date: Dec. 23, 2004

(54) Support element for bicycle accessories and method for making such an element

(75) Inventor: Mario Meggiolan, Creazzo (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 10/863,615

(22) Filed: Jun. 8, 2004

(30) Foreign Application Priority Data
Jun. 10, 2003 (EP) 03425366.6

(51) Int. Cl. A47D 15/00; B62J 11/00; B62J 7/00; B62J 9/00

(52) U.S. Cl. 224/414; 224/425

(57) ABSTRACT

A support element for bicycle accessories consisting of a fixing part for the attachment to the frame of the bicycle and a holding part which receives the accessory. The fixing part and the holding part are distinct from each other and connected through joining means and are both made of polymeric material.

### BACKGROUND

Different types of bottle holders are available to satisfy the different requirements of the amateur and professional cyclist. One objective of manufacturers is to produce bottle holders that merge aesthetic appearance with the characteristics of strength and reliability of the product, and the further objective of reducing the weight. All of these goals are sought while at the same time seeking to minimize production costs.

Known bottle holders usually consist of a part that holds the bottle and a part that attaches to the bicycle frame. Generally, in such bottle holders, the two parts consist of a single body with both the holding part and the fixing part comprising a single shaped rigid metal wire which defines the entire framework where the bottle is received. These types of bottle holders are widely known.

The trend towards making light bottle holders has led to a development of new solutions which use lighter and at the same time stronger materials. Examples of such solutions are described in EP 1 208 031 B1 and EP 1 312 540 A2. In these patents, both the fixing part and the holding part are made from a single body made of carbon fiber. The use of carbon fiber allows on the one hand the overall weight of the bottle holder to be reduced, and at the same time allows it to have particular characteristics of mechanical strength.

EP 1 208 031 B1 describes a holding part with two arms that embrace the bottle longitudinally from the top downwards. They converge at the bottom and are connected together to form a transversal appendage which acts as a support for the bottom of the bottle. EP 1 312 540 A2 describes a holding part with a substantially annular element that defines an opening suitable for insertably receiving the bottle and embracing it transversally with respect to its own axis.

The described bottle holders, however, are costly to produce because of long processing times and waste of expensive material. Such bottle holders are made with sheets of carbon fiber fabric which must first of all be cut into the desired shape, which in general is a complex task. This complex cutting result in long processing times and at the same time results in unusable carbon cut-offs. To further compound the problem of processing times, in a subsequent processing step the sheets of carbon fiber fabric are painstakingly arranged in the desired shape in the mold. Finally, the shaping into a single body involves the use of complex-shaped moulds, and the consequent high production costs.

The final drawback of such bottle holders is that breaking a part thereof requires their complete replacement, the cost of which is passed on to the consumer.

### SUMMARY

The support element and method for making it described herein overcomes all of the above problems. A support element for bicycle accessories comprises a fixing part for the attachment to a bicycle frame and at least one holding part defining a seat for receiving an accessory wherein the part for fixing and the at least one holding part are separate polymeric material parts connected through a joining means

### BRIEF DESCRIPTION OF THE DRAWING(S)

Further characteristics and advantages of the invention shall become clearer from the following description with reference to the attached drawings, provided purely as a non-limiting example, in which:

FIG. 1 represents an isometric view of the bottle holder applied to a bicycle frame;

FIG. 2 represents an exploded isometric view of the bottle holder of FIG. 1;

FIG. 3 represents the bottle holder with the bottle inserted;

FIG. 4 represents an exploded view of a variant embodiment of the bottle holder;

FIGS. 5 and 6 represent some production steps of the parts of the bottle holder according to a first embodiment of the method;

FIGS. 7 and 8 represent a variant embodiment of the method illustrated in FIGS. 5 and 6;

FIG. 9 represents the semi-worked product relative to the holding part of the bottle holder obtained according to the steps represented in FIGS. 5 and 6 and FIGS. 7 and 8;

FIG. 10 represents a variant of the semi-worked product of FIG. 9;

FIG. 11 represents the semi-worked product relative to the fixing part of the bottle holder obtained according to the steps represented in FIGS. 5 and 6 or else in FIGS. 7 and 8.

### DETAILED DESCRIPTION OF THE PREFERRED EMBODIMENTS

In the following description a bottle holder is described but a generic support element for accessories such as glasses, rolled-up rain jackets and the like could also be formed from the holder described.

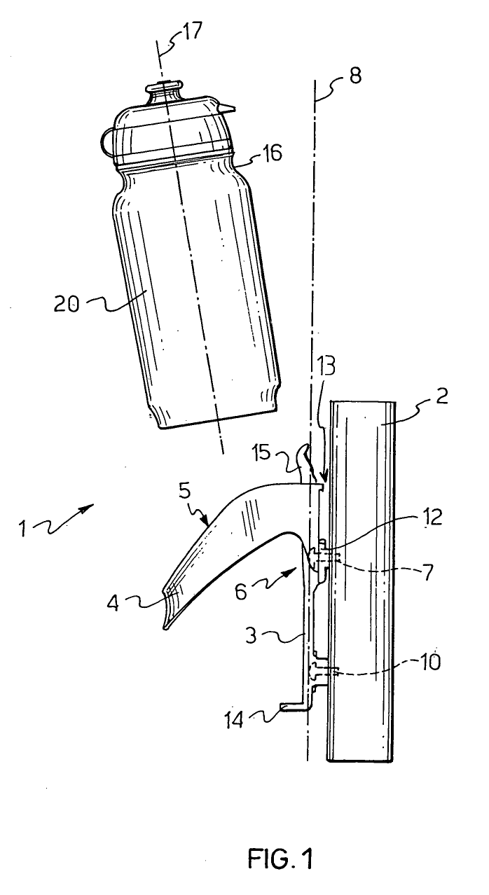

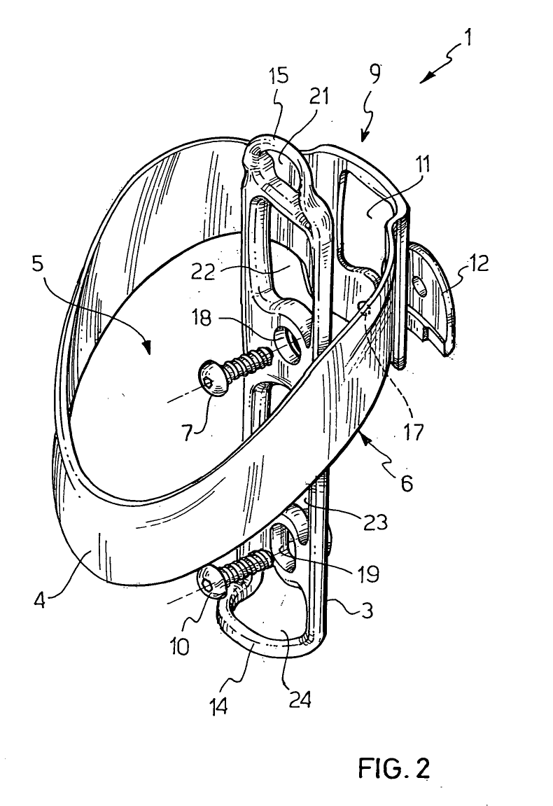

The bottle holder is represented in FIGS. 1 to 3 where it is indicated by reference number 1. FIG. 1 show the bottle holder 1 mounted to the frame 2 of a bicycle. As it can be seen more clearly in FIG. 2, it essentially comprises a fixing part 3 for the attachment to the frame 2 of the bicycle and a holding part 4 associated with the fixing part 3. The holding part 4 defines an open seat 5 with a substantially circular section that mates with the body of a bottle 20. The shape of the changeable seat is formed according to the item being stored therein.

The fixing part 3 and the holding part 4 are connected together through joining means 6 comprising a screw 7 that passes through holes 17 (shown partially in phantom), 18 formed in the holding part 4 and in the fixing part 3 respectively. In different embodiments, instead of the screw 7, a known connection means can be used, like for example rivets or a gluing substance.

The holding part 4 is preferably made with a structural composite material having long structural carbon fibers incorporated in a matrix of thermosetting plastic material, commonly known as “carbon fiber”. The fixing part 3 is made with a plastic material and in particular with a thermoplastic material reinforced with fiberglass, glass beads, or granules of glass. These materials improve the structural strength of the holding part 4 and to the fixing part 3 and at the same time minimize the weight for the support element 1. Different combinations of materials, however, can be foreseen for the parts 3 and 4. For example, both parts 3, 4 can be made of structural composite material, or else both can be made of reinforced or non-reinforced plastic material or the holding part 4 can be made of plastic material and the fixing part 3 can be made of composite material.

The long structural fibers of the composite material can alternatively be chosen among glass fibers, aramidic fibers, ceramic fibers or any combination thereof. The non-structural elements of the reinforced plastic material can be chosen among short carbon fibers, short glass fibers, minerals or any combination thereof. These materials for making the support element preferably have specific weights of less than 2.5 kg/dm³.

The holding part 4 is substantially annular shaped and extends transversally with respect to the axis 8 of extension of the fixing part 3. The fixing part 3 is attached to the frame 2 through a first screw 7 that passes through the holes 17, 18 and a second screw 10 that passes through a hole 19 formed in the fixing part 3. The screws 7, 10 threadedly engage holes in the frame 2 (not shown in the Figures), that allow the attachment of the support element 1 to the bicycle in two places. The screw 7 carries out the dual function of joining the holding part 4 to the fixing part 3 and attaching the support element 1 to the frame 2. The screw could, in different embodiments, be replaced by different but equivalent means, such as a clamp.

The support element 1 has an elastic yielding zone 9 that allows movement of the annular part 4 with respect to the holding part 3, from a first rest position to a second holding position. The elastic yielding zone 9 is obtained in the holding part 4 near the joining zone to the fixing part 3 by means of the through opening 11. The through opening 11 causes the reduction of the rigidity of the holding part 4 near the joining zone to the fixing part 3 and it confers the elasticity that allows said movement between the two parts 3, 4. The size of the through opening 11 is suitably chosen in the design phase to allow the movement of the holding part 4 and, at the same time, to ensure strength and durability.

In an alternate embodiment, the desired elasticity of the holding part 4 can be obtained by using a material with resilient characteristics such as Latamid or Grivory or else through a reduction in thickness of the material with respect to the body of the holding part 4. In other embodiments, the elastic yielding zone 9 can be formed in the fixing part 3 instead of in the holding part 4.

A plastic spacer element 12 placed between the holding part 4 and the bicycle frame 2 allows the correct assembly of the support element 1 to the frame 2. The spacer element 12 creates a free zone 13 that allows the holding part 4 to move without interference with the frame 2.

The fixing part 3 has a substantially longitudinal extension along the axis 8 and has, at its bottom, a support portion 14, in the form of an appendage, that extends perpendicular to the axis 8. The support portion 14 acts as a support to the bottle 20 that is inserted in the seat 5. The fixing part 3 also presents, at the top, an elastically deformable holding fin 15 that extends towards the seat 5 where the bottle 20 is received.

Openings 21, 22, 23, 24 are formed along the body of the fixing part 3 that reduce the weight of the fixing part 3 and support element 1. The through opening 21 formed at the top near the holding fin 15 also allows desired elasticity to be given to the fin 15 itself. In different embodiments the number and shape of such openings can be manufactured as needed. Or else it is possible that, to impart a stronger structure, such openings are not present.

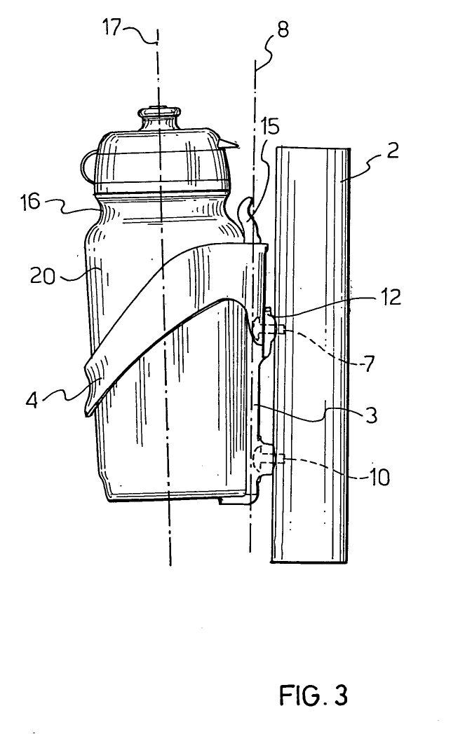

With reference to FIGS. 1 and 3, in use, when the bottle 20 is not inserted inside the support element 1, the seat 5 presents its axis 17 inclined with respect to the axis 8 of the fixing part 3, defining a first rest position for the annular holding part 4. Placement of the bottle 20 in the support element 1 takes place substantially through its insertion in the seat 5 along the direction defined by the axis 17. During such an insertion, the walls of the bottle 20 contact the inner wall of the annular holding part 4, whereas the bottom of the bottle 20 slides along the fixing part 3 until it abuts against the support portion 14. At the same time, the annular part 4 bends around the elastically yielding zone 9 moving from the first rest position, shown in FIG. 1, to a second end position, as represented in FIG. 3. In the end position, the axis 17 of the seat 5 is substantially parallel to the axis 8 of the fixing part 3. The bottle 20 is held in place by the elastic pulling force of the annular part 4 applied by the elastically yielding zone 9. The deformable fin 15 also holds the bottle 20 as it abuts against its outer surface and in particular against the annular recess 16.

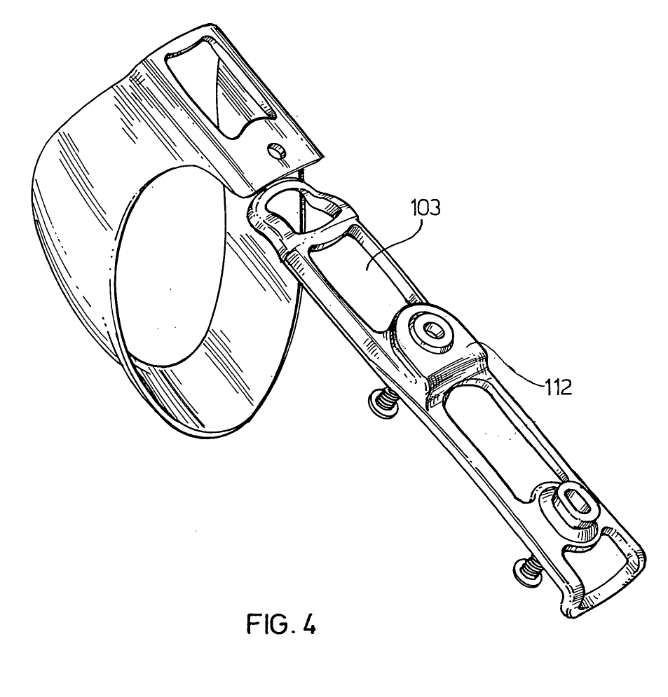

An alternate embodiment is shown in FIG. 4 that differs from the previous one in that the spacer element 112 is a single body with the fixing part 103 and is preferably obtained through a single shaping step by molding the plastic material.

From the foregoing description, the holding part that constitutes the support element constitutes a separate piece until assembly, which allows the fine tuning of a method for making it that leads to benefits in terms of production time and costs.

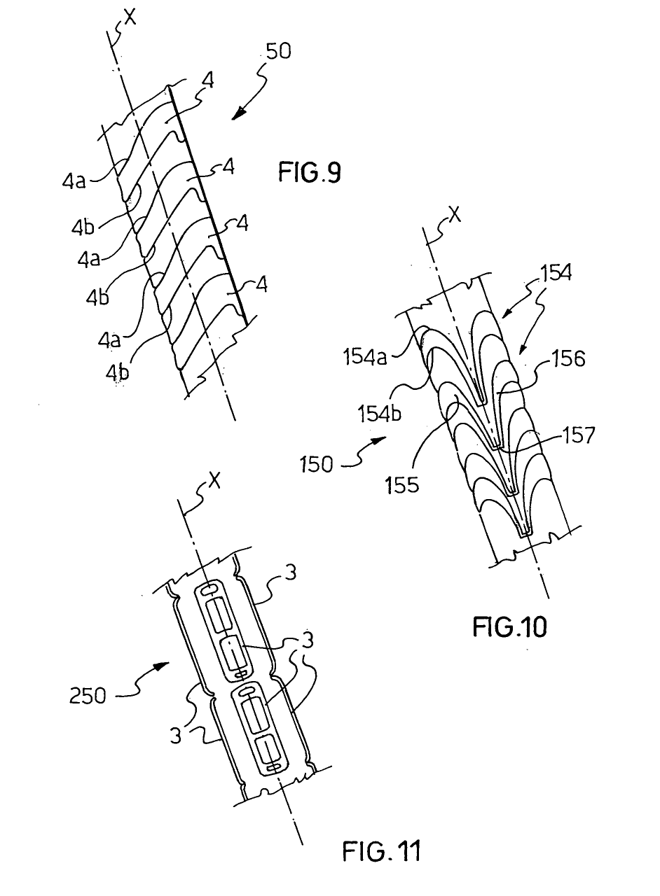

The method uses a tubular element 50, as seen in FIG. 9, with a substantially longitudinal extension along a main direction X, in which the outer surface presents a shape that follows the profile of the holding part 4. Such a shape is successively repeated for the whole length of the tubular element 50 to define a plurality of holding parts 4 in which respective boundary lines 4a, 4b define the side edges thereof. The shaped outer surface of the tubular element 50 is subjected to a cutting step along the lines 4a, 4b to obtain a plurality of holding parts 4. At the same time, or even afterwards, the through hole 11 and the hole 17 are made on the body of each holding part 4.

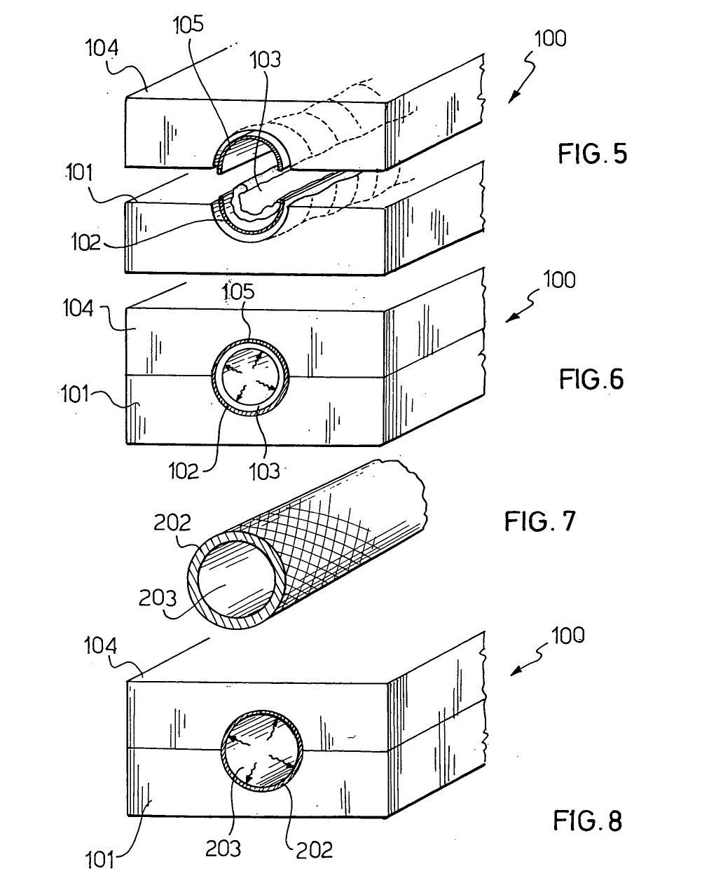

In a preferred embodiment, the holding part 4, and tubular element are made of structural composite material. FIGS. 5 and 6 show a first embodiment of the tubular element 50 shaped in a mould. The first step in forming involves arranging a predetermined number of layers 102 of structural fibers incorporated in a matrix of polymeric material on the inner surface of a first part 101 of a mould 100. Next, an inflatable bag 103 is arranged on such layers 102 whereas a second number of layers 105 of structural fibers incorporated in a matrix of plastic material is applied on the inner surface of the second half 104 of the mould 100. Then the two parts 101, 104 of the mould 100 are brought closet together and the bag 103 is inflated to make the layers 102, 105 adhere to the inner surfaces of the two parts 101, 104 of the mould 100, as it can be seen in FIG. 6. Next, the temperature of the mould is raised, through known heating means, up to a value that allows the reticulation of the polymeric material of the matrix which constitutes the layers 102, 105. Finally, the two parts 101, 104 of the mould 100 are moved apart to remove the tubular element 50, ready to be subjected to the subsequent cutting operations, as described previously.

FIGS. 7 and 8 show a second embodiment of the tubular element 50. The first step in forming involves arranging a predetermined number of layers 202 of structural fibers incorporated in a matrix of polymeric material on the outer surface of a thermo-expandable core 203. The core 203, surrounded by the layers 202, is arranged inside the recess defined by the two halves 101, 104 of the mould 100. Next, the mould 100 is closed and the temperature of the mould is then raised to a value which allows the reticulation of the polymeric material of the matrix that constitutes the layers 202. At the same time, the expanding core 203 keeps the layers 202 in adherence against the inner surfaces of the two parts 101, 104 of the mould 100. Finally, the two parts 101, 104 of the mould 100 are moved apart to remove the tubular element 50, ready to be subjected to the described cutting operations. The core 203 is then removed from the tubular element 50, before or equally after the cutting operations.

The cutting operations are advantageously be made by a high-pressure concentrated water jet incorporating abrasive particles, which is aimed along the curves defined by the boundary lines 4a, 4b of the tubular element 50.

In FIG. 10 a tubular element 150 is shown, obtained for example according to one of the two techniques illustrated in FIGS. 4 to 8, which is used to make a plurality of holding elements, in which the boundary lines 154a, 154b have a different progression to the previous one. With such a configuration a holding element 154 is obtained in which two elongated arms 155, 156 are defined which embrace the bottle 20, when inserted, longitudinally substantially for the whole of its length and support it through the lower appendage 157.

In FIG. 11 a tubular element 250 is shown, obtained for example according to one of the two techniques illustrated in FIGS. 4 to 8, which is used to make a plurality of fixing elements 3.

Finally, the tubular elements 50, 150 or 250 can be made by injection molding of structural composite materials, a technique which foresees the insertion in the mould, at random or in a determined order, of small sheets of structural fibers or of three-dimensional compositions of structural fibers.

What is claimed is:

1. A support element for bicycle accessories comprising a fixing part for the attachment to a bicycle frame and at least one holding part defining a seat for receiving an accessory wherein the fixing part and the at least one holding part are separate polymeric material parts connected through a joining means.

2. The support element of claim 1 wherein at least one of the fixing part or the at least one holding part comprises structural fibers incorporated in a matrix of the polymeric material to form a structural composite material.

3. The support element of claim 1 wherein at least one of the fixing part or the at least one holding part comprises non-structural reinforcement elements incorporated in the polymeric material to form a reinforced plastic material.

4. The support element of claim 2 wherein the structural fibers are selected from the group consisting of carbon fibers, glass fibers, aramidic fibers, ceramic fibers, and any combination thereof.

5. The support element of claim 3 wherein the non-structural reinforcement elements are selected from the group consisting of carbon fibers, glass fibers, glass balls, minerals, and any combination thereof.

6. The support element of claim 1 wherein at least one of the fixing part or the at least one holding part comprises a thermosetting plastic material.

7. The support element of claim 1 wherein at least one of the fixing part or the at least one holding part comprises a thermoplastic material.

8. The support element of claim 1 wherein the holding part is made with a structural composite material and the fixing part is made with a reinforced plastic material.

9. The support element of claim 1 wherein the holding part has a substantially annular cross-section that embraces the accessory.

10. The support element of claim 1 wherein the holding part has a substantially longitudinal extension along a main direction of insertion of the accessory.

11. The support element of claim 9 further comprising an elastic yielding zone suitable for allowing the movement of the annular holding part with respect to the fixing part from a first to a second position when the accessory is inserted into the seat, so that in the second position the annular holding part holds the accessory in the seat.

12. The support element of claim 11 wherein the elastic yielding zone is adjacent to the joining means.

13. The support element of claim 11 wherein the elastic yielding zone is integral with the holding part.

14. The support element of claim 11 wherein the elastic yielding zone is obtained in the fixing part.

15. The support element of claim 11 wherein the holding part and/or the fixing part has a through opening defining the elastically yielding zone.

16. The support element of claim 11 wherein the elastic yielding zone is made from a flexible material.

17. The support element of claim 11 wherein in the first position, an axis of the seat defined by the annular part is inclined with respect to an axis of the fixing part;
wherein in the second position, the axis of the seat defined by the annular part substantially corresponds to the axis of the fixing part.

18. The support element of claim 11 wherein in the first position, an axis of the seat defined by the annular part substantially corresponds to an axis of the fixing part, wherein in the second position, the axis of the seat defined by the annular part is inclined with respect to the axis of the fixing part.

19. The support element of claim 1 further comprising a spacer element between the holding part and the bicycle frame.

20. The support element of claim 19 wherein the spacer element is integral with the fixing part.

21. The support element of claim 1 wherein the joining means comprises a screw.

22. The support element of claim 1 wherein the joining means comprises a rivet.

23. The support element of claim 1 wherein the joining means comprises of gluing substance.

24. The support element of claim 1 wherein the fixing part has an inwardly recessed portion at a bottom portion thereof, for supporting a bottom portion of the accessory.

25. The support element of claim 1 wherein the fixing part has an elastically deformable holding fin at a top portion thereof for engaging the accessory.

26. The support element of claim 1 wherein the holding part has an inwardly recessed portion at a bottom portion thereof for supporting the base of the accessory.

27. The support element of claim 1 further comprising a screw for attaching the fixing part to the bicycle frame.

28. The support element of claim 27 wherein the screw attaches the holding part to the frame.

29. The support element of claim 1 further comprising a clamp attachment means that attaches the fixing part to the frame.

30. A method for making at least one of the parts of a support element for bicycle accessories comprising the steps of:
making a substantially tubular element with an outer surface shaped according to the profile of the parts;
cutting the outer surface of the tubular element according to the shape of the parts.

31. The method of claim 30 wherein the cutting operation is made using a pressurized water jet provided with abrasive particles.

32. The method of claim 30 wherein the outer surface of the tubular element is shaped to obtain a plurality of holding parts that receive the accessories.

33. The method of claim 30 wherein the outer surface of the tubular element is shaped to obtain a plurality of holding parts with a substantially annular configuration.

34. The method of claim 30 wherein the outer surface of the tubular element is shaped to obtain a plurality of fixing parts for attachment to a bicycle frame.

35. The method of claim 30 wherein the making step takes place by shaping in a mold.

36. The method of claim 35 wherein the shaping step comprises the following steps:
applying a predetermined number of layers of structural fibers incorporated in a matrix of polymeric material onto an inner surface of a first part of a mold;
arranging an inflatable bag on the layers;
applying a second predetermined number of layers of structural fibers incorporated in a matrix of plastic material onto the inner surface of a second part of the mold that defines a zone for receiving the bag;
moving the two parts of the mold together;
inflating the bag to make the layers adhere to the inner surfaces of the two parts of the mold;
increasing a temperature in the molds to a value that encourages the reticulation of the polymeric material of the matrix;
moving the two parts of the mold apart to remove the tubular element.

37. The method of claim 35 wherein the shaping step comprises the following steps:
applying a predetermined number of layers of structural fibers incorporated in a matrix of polymeric material onto an outer surface of a thermo-expandable core;
arranging the core coated with fibers inside a tubular recess defined by the mold;
increasing a temperature within the mold to a value that encourages the reticulation of the polymeric material of the matrix and the expansion of the core.

38. The method of claim 37 further comprising the step of removing the core.

39. The method of claim 35 wherein the shaping steps is accomplished using injection molding.

40. An accessory holding device for a bicycle comprising:
a closed loop band with at least a portion thereof being flexible, the band engaging a bracket mountable to a bicycle frame, the bracket having at least one protrusion that helps secure an accessory within the closed band and against the bracket.

41. An accessory holding device for bicycles, the device comprising:
a fixing part parallel to an axis AS and configured to be fixed to the frame of a bicycle, having spaced apart first and second ends; and
a holding part connected at the second end of the fixing part and extending toward the axis AS; and
a closed holding portion, substantially of annular shape, elastically connected to the fixing part at the first end thereof and defining a through aperture that is generally centered around an axis AF that forms a given incidence angle AI with respect to the axis AS;
wherein introduction of an accessory to be held into the closed holding portion causes said holding portion to pivot into a holding position and alters said given incidence angle AI; and
wherein the fixing part and the holding part are separate but connected polymeric material parts.
